(19) United States
(12) Patent Application Publication
(10) Pub. No.: US 2023/0316172 A1
(43) Pub. Date: Oct. 5, 2023

(54) SYSTEMS AND METHODS FOR AUTOMATICALLY ASSIGNING A TASK

(71) Applicant: Divisions Maintenance Group, Newport, KY (US)

(72) Inventors: Tayeb AYAT, Newport, KY (US); Jim WOODS, Hudson, FL (US); Zhihong CHEN, Mason, OH (US); Siddharth GOYAL, Cumming, GA (US)

(21) Appl. No.: 17/713,776

(22) Filed: Apr. 5, 2022

(51) Int. Cl. G06Q 10/06; G06N 5/02; G06F 40/20; G06F 40/40

(52) U.S. Cl. CPC G06Q 10/06311; G06F 40/40; G06F 40/20; G06N 5/022

(57) ABSTRACT

A method for using natural language data to analyze tasks via machine learning, includes obtaining task data indicative of at least one task, and including natural language data associated with the at least one task; converting the task data into task feature data; and generating an evaluation of the at least one task by using a trained machine-learning model on the task feature data. The trained machine-learning model has been trained based on historical task feature data and historical evaluations associated with the historical task feature data to learn associations between the historical task feature data and the historical evaluations, so that the trained machine-learning model is configured to use the learned associations to generate the evaluation based on the task feature data.

### TECHNICAL FIELD

Various embodiments of this disclosure relate generally to machine learning based techniques for generating an evaluation of at least one task, and, more particularly, to systems and methods for generating an evaluation of at least one task by using a trained machine learning model on task feature data.

### BACKGROUND

Currently, maintenance facilitators generally rely on human knowledge to evaluate maintenance requests. Performing an evaluation may involve a series of steps, e.g., ticket creation, provider evaluation calculation (not-to-exceed cost), job posting, provider evaluation update (update to not-to-exceed cost), scheduling and coordination with provider, invoicing at job completion, etc. to create and fulfill a single maintenance item. Accomplishing one or more items of maintenance can, on average, take up to a week for even the smallest jobs. The number and complexity of manual steps required to accomplish such jobs may lead to inefficiencies. Moreover, because of the uncertainty associated with pricing a particular maintenance task, maintenance facilitators often assign maintenance tasks to maintenance providers at price points that are inaccurate, and/or unattainable by the provider. In many case, the maintenance provider may need to adjust their initially quoted price multiple times before, and even during performance of the task, which may add frustration, complexity, and/or cost to the maintenance facilitators and the ultimate customer.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating an evaluation of at least one task by using a trained machine learning model on task feature data.

In one aspect, a computer-implemented method for using natural language data to analyze tasks via machine learning, includes obtaining task data indicative of at least one task, and including natural language data associated with the at least one task; converting the task data into task feature data; and generating an evaluation of the at least one task by using a trained machine-learning model on the task feature data. The trained machine-learning model has been trained based on historical task feature data and historical evaluations associated with the historical task feature data to learn associations between the historical task feature data and the historical evaluations, so that the trained machine-learning model is configured to use the learned associations to generate the evaluation based on the task feature data.

In another aspect, a system for using natural language data to analyze tasks via machine learning includes: a display; a memory storing instructions and a trained machine learning model. wherein (i) the trained machine-learning model has been trained based on historical task feature data and historical evaluations associated with the historical task feature data to learn associations between the historical task feature data and the historical evaluations, and (ii) the training has resulted in the trained machine learning model being configured to use the learned associations to generate an evaluation based on task feature data; and a processor operatively connected to the display and the memory, and configured to execute the instructions to perform operations. The performed operations may include: obtaining task data indicative of at least one task, and including natural language data associated with the at least one task; converting the task data into the task feature data; and generating the evaluation of the at least one task by using the trained machine-learning model on the task feature data.

In yet another aspect, a computer-implemented method for using natural language data to analyze tasks via machine learning includes obtaining task data indicative of at least one task, and including natural language data associated with the at least one task; converting the task data into task feature data; and generating an evaluation of the at least one task by using a trained machine-learning model on the task feature data. The trained machine-learning model has been trained based on historical task feature data and historical evaluations associated with the historical task feature data to learn associations between the historical task feature data and the historical evaluations, so that the trained machine-learning model is configured to use the learned associations to generate the evaluation based on the task feature data, and automatically assigning the at least one task to a technician based on the evaluation of the at least one task.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for training and/or using a machine learning model to generate an evaluation of at least one task by using a trained machine learning model on task feature data, according to one or more embodiments.

FIG. 2 depicts an exemplary workflow schematic for training and/or using a machine learning model to generate an evaluation of at least one task by using a trained machine learning model on task feature data, according to one or more embodiments.

FIG. 3 depicts a flowchart of an exemplary method of training a machine learning model to generate an evaluation of at least one task, according to one or more embodiments.

FIG. 4 depicts a flowchart of an exemplary method of using a trained model to generate an evaluation of at least one task by using a trained machine learning model on task feature data, according to one or more embodiments

FIG. 5 depicts a flowchart of an exemplary method for processing raw input data for use by a machine learning model, according to one or more embodiments.

FIG. 6 depicts a simplified functional block diagram of a computer that may be configured as a device for executing the methods disclosed herein, according to one or more embodiments.

### DETAILED DESCRIPTION OF EMBODIMENTS

According to certain aspects of the disclosure, methods and systems are disclosed for generating an evaluation of at least one task by using a trained machine-learning model on task feature data associated with the at least one task. A task may be, for example, a maintenance task generated by a task generator, such as an occupant, owner, or tenant of an industrial, commercial, or residential site. It may be desirable for occupants, owners, or tenants of sites to generate maintenance tasks for assignment and completion by one or more technicians and to have such tasks evaluated. However, conventional techniques for generating an evaluation of one or more maintenance tasks and assigning the one or more maintenance tasks may not be suitable. Accordingly, improvements in technology relating to automatically evaluating and assigning tasks are needed.

As will be discussed in more detail below, in various embodiments, systems and methods are described for obtaining task data indicative of at least one task, converting the task data into task feature data, and generating an evaluation of the at least one task by using a trained machine-learning model on the task feature data to evaluate the task. By training a machine-learning model, e.g., via supervised or semi-supervised learning, to learn associations between task feature data and task data, the trained machine-learning model may be usable to evaluate one or more tasks and/or assign the one or more tasks to one or more technicians.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, terms such as “task data” or the like generally encompass data associated with one or more maintenance tasks at an industrial, commercial, and/or residential facility, e.g., that may require a technician to complete. Task data may refer to a maintenance task and/or particular aspects of that task such as individual component parts of the task (e.g., subtasks), a timeline of task completion and/or particular milestones associated with task completion, an urgency of a task, a classification of a customer (e.g., a customer's overall book of maintenance, location, maximum allocation for maintenance, history of fees paid, etc.) an identity of one or more technicians which may bid for and/or be assigned one or more tasks, the identity of a task generator (e.g., customer) requesting the task, a location of the task, a cost of the task (estimated, hypothetical, actual, etc.), a “not-to-exceed” cost of the task, a service type of the task (e.g., electrical, plumbing, information-technology, etc.), or other data associated with the task. Examples of various task data includes, but is not limited to, data associated with mowing a lawn, replacing a street light, mending a broken fence, sweeping a parking lot, excavating earth, etc. In some embodiments, an identity of the task generator may be target encoded (e.g., via financial aggregation) to classify the task generator based on its specific budget or price discrimination.

As used herein, the term “historical task data” may be associated with historical tasks that have been completed. In some embodiments, the historical task data may be grouped into one or more groups based on the characteristics of the tasks described in the historical task data. For example, the historical task data may be labeled based on a particular type of job completed in the task (e.g., electrical, mechanical, plumbing, landscaping, etc.) The historical task data may be labeled based on location of the task to be completed or a location of the entity requesting the task (e.g., the task generator 120). Historical task data may be labeled as routine work or non-routine work. Historical task data may be labeled based on an urgency of the tasks within the historical task data. For example, the historical task data may be labeled on a sliding scale of urgency (e.g., 1 to 5, etc.) In some embodiments, the historical task data may be labeled to include a task generator-defined service type (e.g., electrical, mechanical, plumbing, landscaping, etc.) In some embodiments, the historical task data may be labeled based on a budget or price tolerance of the task generator.

As used herein, the term “maintenance facilitator” may refer to, for example, a person, organization, or entity that provides, facilitates, or offers, or contracts for performance of one or more tasks, e.g., as defined by one or more work orders, scopes of work, or the like.

As used herein, the term “task generator” may refer to, for example, a customer, client, or patron of a maintenance facilitator and/or a technician. The task generator may be, for example, a business, a corporation, or other entity, a person, or other individual. The task generator may generate one or more work orders (e.g., replace a group of lightbulbs in a parking lot). The task generator may comprise a name, which name may be indicative of a task generator size (number of employees, market capitalization, etc.)), a task generator location (e.g., a zip code), a task generator defined service type, or other factors (e.g., the amount of maintenance work they perform every year (as measured by total maintenance expenditures, local maintenance expenditures, man-hours, the length of time they have been generating work orders, and etc.)

As used herein “technician data” or the like generally encompass data associated with a particular technician. Such data may include, but is not limited to, number of work orders filled, average amount charged to complete a work order, average time required to complete a work order, identifying information such as name, contact information, etc., number of times worked with a given customer, etc.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or semi-supervised training may be employed. For example, supervised learning may include providing training data and labels corresponding to the training data, e.g., as ground truth. Any suitable type of training may be used, e.g., stochastic, gradient boosted, random seeded, recursive, epoch or batch-based, etc.

Conventionally, fulfilling a task request involves receiving a scope of work (or “work order”) including task data describing one or more tasks from a generator of the task (e.g., a customer) and assigning the scope of work to one or more technicians to complete the one or more tasks. The scope of work may be reviewed and/or edited by an employee for accuracy before it is assigned to the one or more technicians. The work order may be assigned to the one or more technicians based on the identity of the task generator, the type of work in the work order, the expected cost of the work order, and other factors associated with the particular tasks therein. Also, the work order may be assigned to the one or more technicians based on work history of each of the one or more technicians, for example, the number of jobs completed, the type of jobs completed, the speed and accuracy of completed jobs, a physical location of the technician as compared with the work site, etc. However, as noted above, this conventional process may be time consuming, complex, and/or inaccurate.

In an exemplary use case of the present disclosure, a machine-learning model may be trained to evaluate a scope of work and/or other task data, whereby the scope of work may be assigned to a technician, e.g., automatically, via a human user, or combinations thereof. Training data that includes natural language descriptions of tasks or work to be completed by technicians, and ground truth including the costs and/or evaluations associated with the tasks, may be used to train the machine learning model, e.g., to develop associations between the training data and the ground truth, e.g., between task data and costs or evaluations for associated tasks.

Presented below are various aspects of machine learning techniques that may be adapted to generate an evaluation of at least one task by using a trained machine-learning model on task feature data. As will be discussed in more detail below, machine learning techniques adapted to generating an evaluation of at least one task may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

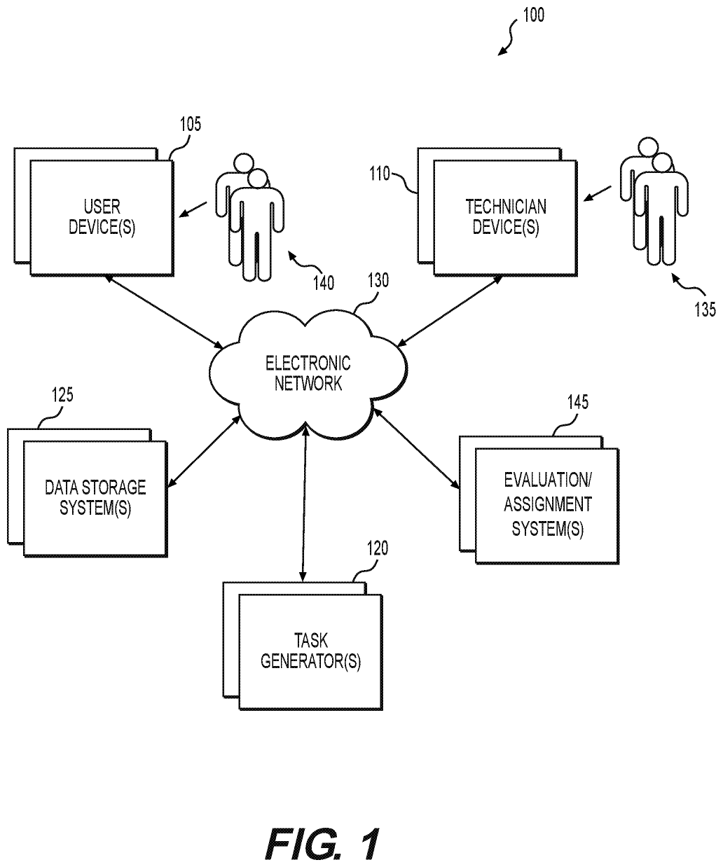

FIG. 1 depicts an exemplary environment 100 that may be utilized with techniques presented herein. One or more user devices 105 used by one or more users 140 (e.g., a task generator, an employee, etc.), one or more technician devices 110 used by one or more technicians 135, one or more task generators 120, an evaluation and assignment generation system(s) 145, and one or more data storage systems 125 may communicate across an electronic network 130. As will be discussed in further detail below, the evaluation and assignment generation system 145 may communicate with one or more of the other components of the environment 100 across electronic network 130 in order to train and/or use a machine learning model to generate evaluations of tasks by applying learned associations to task data.

In some embodiments, components of the environment 100 are associated with a common entity, e.g., a maintenance contracting service provider, or the like. In some embodiments, one or more of the components of the environment is associated with a different entity than another. The systems and devices of the environment 100 may communicate in any arrangement. As will be discussed herein, systems and/or devices of the environment 100 may communicate in order to generate, train, and/or use a machine-learning model to generate an evaluation of the at least one task, among other activities.

The one or more user device(s) 105 and the one or more technician device(s) 110 may comprise an input/output device (e.g., a touchscreen display, keyboard, monitor, etc.) may be associated with the user 140, e.g., a user associated with one or more of generating, training, or tuning a machine-learning model for generating an evaluation of at least one task, generating, obtaining, or analyzing task or technician data, and/or assigning the at least one task to one or more technicians 135.

The user device 105 may be configured to enable the user 140 to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105. In some embodiments, the electronic application(s) may be associated with one or more of the other components in the environment 100. For example, the electronic application(s) may include one or more of system control software, system monitoring software, software development tools, etc.

The data storage system 125 may include a server system, an electronic medical data system, computer-readable memory such as a hard drive, flash drive, disk, etc. In some embodiments, the data storage system 125 includes and/or interacts with an application programming interface for exchanging data to other systems, e.g., one or more of the other components of the environment. The data storage system 125 may include and/or act as a repository or source for task data, task feature data, technician data, and/or technician feature data.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the evaluation and assignment generation system 145 may generate, store, train, and/or use a machine-learning model configured to generate an evaluation of at least one task. In some embodiments, the at least one task may then be assigned to at least one technician, e.g., automatically, by the user 140, or by a combination thereof. The evaluation and assignment generation system 145 may include a machine-learning model and/or instructions associated with the machine-learning model, e.g., instructions for generating a machine-learning model, training the machine-learning model, using the machine-learning model etc. The evaluation and assignment generation system 145 may include instructions for retrieving evaluation data and/or technician data, adjusting evaluation data and/or technician data, e.g., based on the output of the machine-learning model, and/or operating a display to output evaluation data and/or technician data, e.g., as adjusted based on the machine-learning model. The evaluation and assignment generation system 145 may include training data, e.g., historical task data, and may include ground truth data, e.g., evaluation and assignment data.

The training data may include historical task data which may include historical scopes of work. Additionally, the training data may include data related to the urgency of a particular scope of work for historical tasks (e.g., historical tasks that have been completed, etc.), name data (e.g., task generator identity (“Store Mart”)), location (e.g., zip code), service type (e.g., landscaping, mechanical, electrical, etc.)

Task data and/or historical task data may include scopes of work having raw text input by a task generator, which may include descriptions of tasks, lists of subtasks to be completed when completing a task, equipment lists required for completing a task, and other data associated with the task (examples of tasks may include, without limitation, changing the lightbulbs in a parking lot, replacing an outlet in an office space, installing a light fixture, mowing a lawn, filling a pot hole in a parking lot, etc.)

A scope of work and/or an historical scope of work may include natural language data related to deliverables, timelines, milestones, reports, expenses, tasks, materiel, etc. In some embodiments, the scopes of work and/or historical scopes of work may describe how project goals may be achieved. The scopes of work and/or historical scopes of work may be broken down into specific phases. The scopes of work and/or historical scopes of work may include details such as project location, schedule, standards and testing, project requirements, payment information, etc.

In some embodiments, a system or device other than the evaluation and assignment generation system 145 is used to generate and/or train the machine-learning model. For example, such a system may include instructions for generating the machine-learning model, the training data and ground truth, and/or instructions for training the machine-learning model. A resulting trained-machine-learning model may then be provided to the evaluation and assignment generation system 145.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between task feature data and task data and technician feature data and technician data, such that the trained machine-learning model is configured to determine an output evaluation and/or assignment in response to the input task data or technician data based on the learned associations.

In some instances, different samples of training data and/or input data may not be independent. For example, some data associated with various technicians and work orders may be related, e.g., for a given geographical area, for particular types of work, or due to a likelihood that a given technician will routinely perform the same type of work, or that a technician will perform most or all of the technician's work within a particular radius of a given location. Thus, in some embodiments, the machine-learning model may be configured to account for and/or determine relationships between multiple samples, e.g., to assign tasks efficiently.

Although depicted as separate components in FIG. 1, it should be understood that a component or portion of a component in the environment 100 may, in some embodiments, be integrated with or incorporated into one or more other components. For example, a portion of a display may be integrated into the user device 105 or the like. In another example, the evaluation and assignment generation system 145 may be integrated the data storage system 125. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to generate an evaluation of at least one task by using a trained machine learning model, which task may be automatically assigned to a trained technician, are discussed in further detail in the methods below. In the following methods, various acts may be described as performed or executed by a component from FIG. 1, such as the evaluation and assignment generation system 145, the user device 105, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

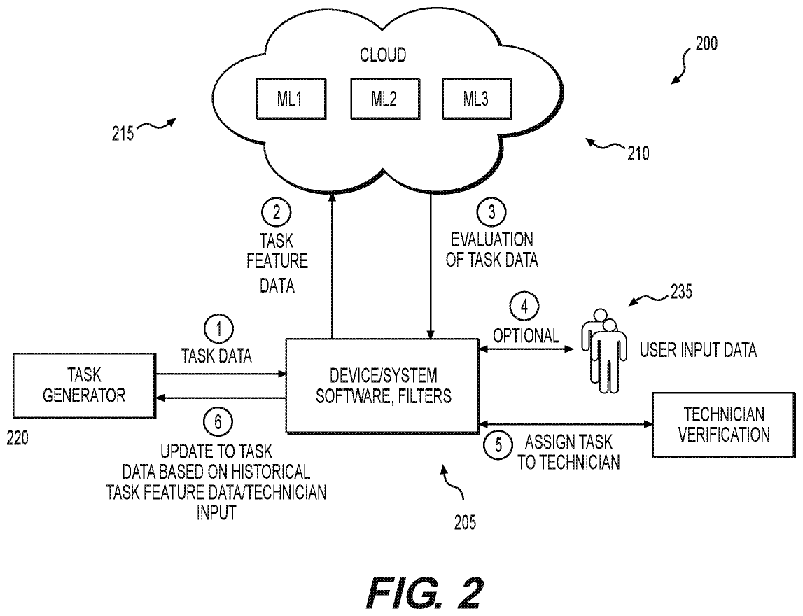

FIG. 2 illustrates an exemplary workflow schematic 200 for using and/or training a machine-learning model to automatically evaluate a task for possible automatic and/or manual assignment to a technician, such as the technician 135 of FIG. 1, using one or more trained machine learning models. The schematic 200 includes a device (or system) 205 that may be communicatively coupled to an electronic network 210. (e.g., a cloud network). The electronic network 210 may be configured to execute one or more machine learning algorithms 215 to learn to evaluate at least one task, which task(s) may be automatically assigned to one or more technicians. Task data may be obtained (1) from a task generator 220. The task generator 220 may be an entity (e.g., customer, client, etc.) that generates the task data for a task (e.g., order, job description, etc.), and the task data may include a task description with features of the task. In some embodiments, the task generator 220 may be classified within or from individual or groups of task generators during preprocessing of the task data as described herein. The task generator 220 may be classified based on historical task data and/or historical task feature data, which may include, for example, its size, its location, and its history of task evaluations. Classification of the task generator is described herein below.

In some embodiments, the task data may include task description information in a natural language format and/or may include other information or data associated with the task. The device 205 may obtain the task data and perform one or more pre-processing operations, e.g., filters, on the task data before transmitting (2) task feature data to the electronic network 210. For example, the device 205 may perform one or more filters or pre-processing steps such as Lemmatization, Tokenization, Stemming, TFIDF or Word2vec, or the like in order to convert the task data into task feature data. In some embodiments, the electronic network 210 may perform one or more filters. Further details for pre-processing of task data is provided below.

The electronic network 210 may include and/or provide access to one or more machine learning algorithms 215. In various embodiments, the machine learning algorithms may be hosted or implemented on any suitable machine. In the exemplary workflow depicted in FIG. 2, the machine learning algorithms are distributed in a cloud implementation that includes multiple servers ML1, ML2, ML3, etc. The machine learning algorithms 215 may have been trained on historical task feature data and historical evaluations associated with the historical task feature data to learn associations between the historical task feature data and the historical evaluations. In some embodiments, the electronic network 210 may be configured to perform natural language processing on natural language data received from the device 205 and/or to apply a predetermined filter to the natural language data, e.g., to convert raw task data into task feature data that is in a form accepted by the machine learning algorithms 215. For example, with specific reference to FIG. 2, in some embodiments, one or more of the task data at step 1 may be provided from the task generator 220 directly to the electronic network 210 for pre-processing or other processing prior to machine learning.

The machine learning algorithms 215 may then generate an evaluation of the task(s) from the task generator 220 by applying learned associations between historical task feature data and the historical evaluations to the input task feature data to generate a new evaluation. The electronic network 210 may then transmit (3) the evaluation of the task(s) to the device 205 for further distribution.

In some embodiments, the device 205 may provide (4) the task data and/or task feature data to a user 235 (e.g., an employee) for review and verification, e.g., prior to employing and/or re-employing the machine learning algorithms 215. In some embodiments, the user may verify the information within the task and/or task feature data and edit the data as appropriate. The user may return the edited task data and/or task feature data to the device 205 as user input data.

In some embodiments, the device 205 may be configured to obtain technician data indicative of at least one technician. The technician may be, for example, an entity assigned to complete the task(s). Technician data may include, for example, a history of task completion, a rating of historical tasks (e.g., great, good, fair, poor, etc.) with respect to particular aspects of the task. Technician data may be received at the device 205 or within the electronic network 210. In some embodiments, a user 235 may input technician data or update technician data based on a history of task completion by the one or more technicians. The technician data may be input, for example, in a natural language format and may be subjected to one or more filters before or after it is input to the device 205.

In some embodiments, one or more of the device 205 and the electronic network 210 may generate or transmit (5) an assignment of the task to a technician based on the task data and the technician data. In some embodiments, the assignment may be based at least in part upon the task data, the evaluation, or the like. In some embodiments, the user 235 may review the automatically generated task assignments and may provide user oversight with respect to the evaluation and/or assignments of tasks. In some embodiments, the user input may change the assignment of the task from one technician to another technician. In some embodiments, the user 235 may provide the assignment of the technician.

In some embodiments, an assigned technician may provide input to the task data or the evaluation generated based on the task data (e.g., verify that the evaluation is appropriate for a given set of tasks). This technician verification data may be used by the device 205 to develop more accurate machine learning models to better assign generated tasks to technicians, and/or may be used to update or adjust (6) the task data and/or task feature data prior to re-employing the machine learning algorithms 215 in order to update the evaluation based on the technician's feedback.

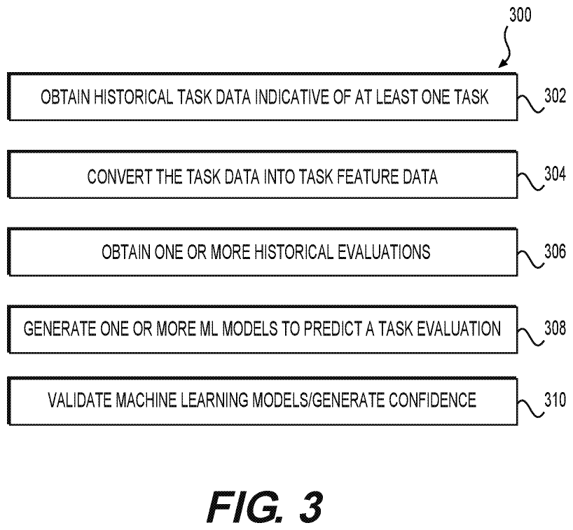

FIG. 3 illustrates an exemplary process 300 for training a machine learning model 215 to evaluate at least one task, e.g., using the electronic network 130 of FIG. 1. At step 302, the historical task data (as defined herein) may be obtained. The historical task data may be obtained, for example, from a database of historical task data (e.g., the device 205 of FIG. 2).

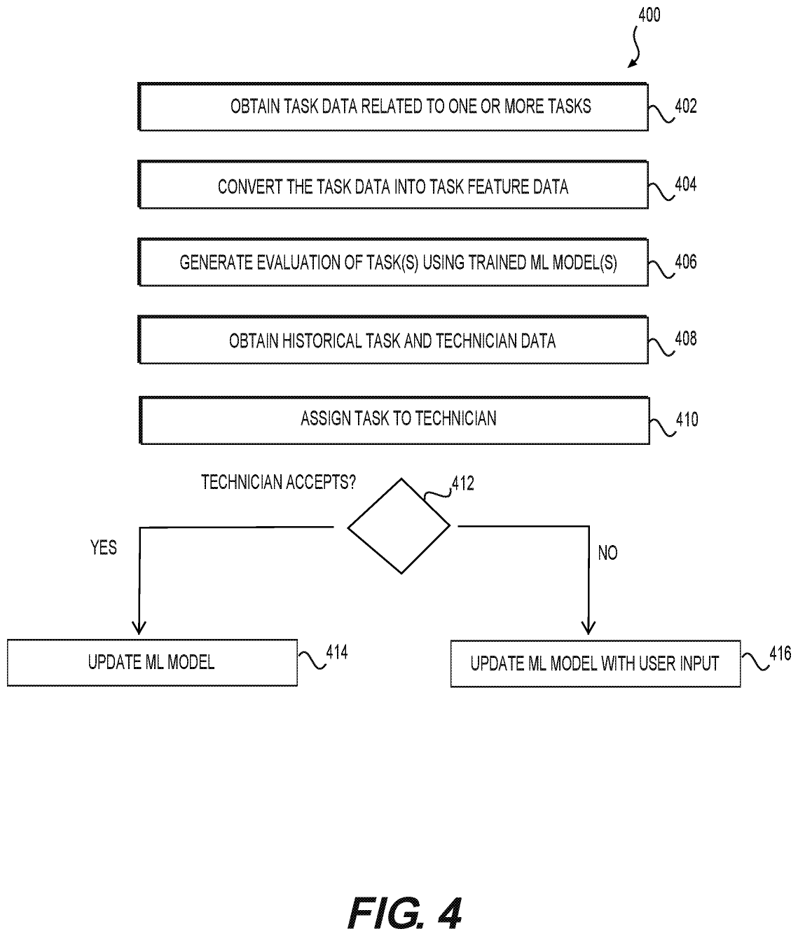

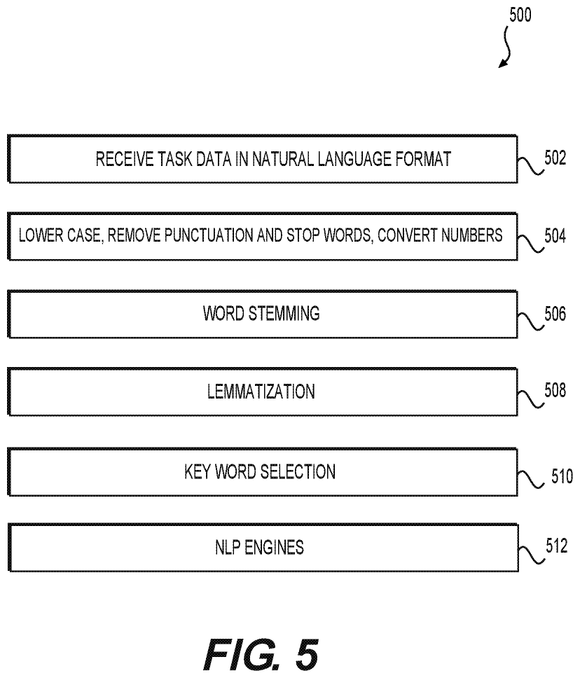

At step 304, the historical task data may be converted to historical task feature data. However, it should be understood that in some embodiments, pre-converted task data may be obtained, e.g., so that steps 302 and 304 may be omitted or supplemented. In some embodiments, the historical task data may be converted based on mandatory transformations and/or optional quality transformations as described in greater detail herein, especially with respect to process 400 of FIG. 4. The pre-processing and filtering steps are described in greater detail herein, especially with respect to process 500 shown in FIG. 5

In some embodiments, a certain portion (e.g., a percentage (10%, 20%, etc.) of the historical task data may be used as test data to test the machine learning models developed using the methods described herein. This test data may be reserved separately from the historical task data and historical task feature data that may be used to train the models and the test data may be used to develop confidence intervals in the data as explained in greater detail herein.

At step 306, one or more historical evaluations may be obtained. The historical evaluations may be a particular value (e.g., a price) associated with one or more tasks or subtasks or may be in a natural language format. The historical evaluations may include evaluations of the one or more tasks in the historical task data (i.e., what a particular historical task cost to perform). The historical evaluations may be itemized by particular subtask. In some embodiments, the historical evaluations may include data associated with an identity of the evaluator. In some embodiments, obtaining the one or more historical evaluations may include parsing price information from the one or more historical evaluations, e.g., performing natural language processing, accounting for itemized pricing, etc. In some embodiments, a certain portion (e.g., a percentage (10%, 20%, etc.) of the historical evaluation data may be used as test data to test the machine learning models. This test data may be reserved separately from the historical evaluation data used to train the models and may be used to develop confidence intervals in the data as explained in greater detail herein. In the case of using natural language historical evaluation data, such natural language data may be subjected to pre-processing or processing steps as described herein (e.g., vectorization, etc.)

At step 308, the historical task feature data and the historical evaluations may be used to train one or more trained machine learning models that may be used, for example, to predict a task evaluation for given task data. The trained machine learning model(s) may be trained to learn associations between the historical task feature data and the historical evaluations, so that the trained machine-learning model is configured to use the learned associations to generate the evaluation based on the task feature data.

At step 310, the machine learning model(s) generated in step 308 may be validated and/or one or more confidences may be generated based on the machine learning model(s). The machine learning model(s) may be validated, for example, using data which has not been previously presented to the machine learning model(s). For example, the machine learning model(s) may be validated using test data reserved for validation (e.g., the test data described above with respect to the historical task data, historical evaluations, and task data discussed herein). The test data may have been randomly split from the historical data, for example. In some embodiments, there may be a specific holdout data set from the historical data. The data may be tested using any method, for example, a k-Fold Cross-Validation (k-Fold CV), a Leave-one-out Cross-Validation (LOOCV), a Leave-one-group-out Cross-Validation (LOGOCV), a Nested Cross-Validation, a Time Series CV, etc.

Additionally, one or more confidence intervals or confidence levels may be generated. The confidence intervals or levels may, for example, measure the uncertainty in the evaluations generated using test data on the one or more machine learning models generated at step 308. The confidence interval or level may quantify, for example, an uncertainty of an evaluation, a repeatability of a particular task, or an accuracy of an evaluation of one or more tasks. The confidence level may provide a lower and upper bound of the evaluation. In some embodiments, the confidence interval may provide a likelihood of a particular evaluation. In some embodiments, confidence levels may be generated using one or more separate machine learning tasks. In an exemplary use case, the confidence interval or level may be used to determine particular criteria for which a particular trained model is more accurate. For example, the test data may include different portions of test data that correspond to different price ranges. By evaluating the trained model with test data from each price range, confidence, accuracy, and/or other factors may be determined for the trained model for each portion of the test data, e.g., for each price range. In this manner, one or more price ranges may be determined for which the trained model is more efficient, accurate, or the like. Further, multiple trained models may be evaluated in this manner, e.g., to identify different models that are more efficient or accurate for each of the different price ranges. While price range is used as an example herein, any suitable criteria may be similarly used, e.g., service type, location, urgency, customer, etc.

FIG. 4 illustrates an exemplary process 400 for generating an evaluation of at least one task, e.g., by utilizing a trained machine-learning model such as a machine-learning model trained according to process 300 discussed above. At step 402, the user 140 and/or the data storage system 125 may obtain task data related to one or more tasks, e.g., from one or more task generators 220 and/or from another source (e.g., the data storage system 125). The task data may include natural language data associated with one or more of the one or more tasks.

At step 404, the task data may be converted into task feature data. The conversion may take place, for instance, at the data storage system 125 or in the electronic network 130. The conversion may include, for example, one or more pre-processing steps and/or feature engineering steps (e.g., as Lemmatization, Tokenization, Stemming, TFIDF or Word2vec) to understand the contents of the task data, including contextual nuances. The conversion may generate multiple features through one or more of pre- and post-processing to quantify the task data (e.g., text). The processing of task data may include, but is not limited to, making all words lower case, removing punctuation, removing “stop words,” converting digital numbers to textual form, word stemming, lemmatization, key word selection (e.g., top 100 words, 1,000 words, 2,000 words, etc.). Key words may be assigned, for example, by a user, a technician, or a task generator. In some embodiments, key words may be based on automatic key word extraction and/or automatic key-phrase abstraction. For example, the historical task data may be processed to automatically extract a set of the most important words (e.g., 100 words, 1,000 words, etc.) and the set of most important words may be labeled as key words in one or more trained machine learning models. However, in some embodiments, the key words may not be within the historical task data itself. The historical task data may include one or more historical subtasks associated with the historical task data and key words may be included in the historical subtasks.

At step 406, an evaluation of the at least one task may be generated using the trained machine learning model on the task feature data. The trained machine-learning model may have been trained based on: (i) historical task feature data, and (ii) historical evaluations associated with the historical task feature data, such as via the process 300 discussed above. The trained machine learning model may have been trained to learn associations between the historical task feature data and the historical evaluations, so that the trained machine-learning model is configured to use the learned associations to generate the evaluation based on the task feature data.

In some embodiments, the trained machine learning model may be most accurate for evaluations with a particular value or range of values. For example, the evaluation may be most accurate at predicting evaluations of tasks with a valuation of between, for example, $100 and $10,000, $150 and $5000, $200 and $3500, etc. In some embodiments, the process 400 may include one or more steps for filtering tasks that do not fall at a particular accurate value or within a particularly accurate range of values such that the tasks are not automatically assigned or are subject to additional processing. In some embodiments, these tasks with values outlying a most accurate subset of values may be reviewed and assigned, for instance, by a user, such as the user 235 of FIG. 2. For example, a user may label data associated with the outlying evaluations (e.g., with a price, with details regarding the scope of work, etc.)

One or more of the one or more machine learning models may predict whether the one or more tasks is evaluated below an evaluation ceiling (for example, if a particular evaluation is less than $100, $200, etc.) The evaluation ceiling could be set at any level. The evaluation ceiling may be based on the most accurate evaluation level that is generated using the ML models described herein. For example, if the ML model is most accurate at evaluating tasks with a value of less $200, the evaluation ceiling might be set at $200. Based on the accuracy, density, and readability of the historical task data and historical task evaluations, evaluations at various levels might be more or less accurate. Hence, it might be useful to apply an evaluation ceiling to only generate and/or assign evaluations which have a total value of less than the evaluation ceiling. One or more of the ML models may be used to generate the price ceiling and/or apply it to evaluations generated using the process 400.

At step 408, the user 140 and/or the data storage system 125 may obtain historical task data indicative of at least one task and/or historical technician data indicative of at least one technician. The technician data may include information relating to the technician. For example, the name, location, size, task history, task bid history, task completion history, task evaluation history and other information about the technician. The technician data may include data related to the tasks completed by the technician as compared with the price the technician was willing to complete a particular job for. At step 410, the one or more tasks may be assigned to a technician, e.g., automatically, by a user 140, or a combination thereof. For example, if there is a large difference between the price the technician had been willing to complete a task for and the evaluation of a particular task (e.g., the evaluation is much higher than the previously-performed price), the task may be automatically assigned to that technician at step 410.

In some embodiments, the assignment may be generated based on a confidence interval of the evaluation of the at least one task. The confidence interval may be a quantification of a certainty of the evaluation of the at least one task in light of the historical evaluations associated with the historical task feature data and/or the historical technician feature data. The confidence interval associated with a particular evaluation may determine whether or not it is later automatically assigned to a technician. For example, if an evaluation is determined with 95% confidence, the task(s) associated with the evaluation may be automatically assigned to a technician based on their relatively high confidence interval.

At step 412, the technician may accept the assigned task or not. If the technician accepts the assigned task, the machine learning model may be updated based on the amount of time it took for the technician to accept the task at step 414. That is, the amount of time that it takes a technician to accept a task may be indicative of a difference between the evaluation of the task(s) and the cost a technician anticipates for the task(s). If the technician anticipates a high cost, the technician may be more likely to accept the task(s) quickly. However, if the technician waits to accept the task, it may indicate deliberation and be an indicator that the task(s) are not seen as particularly profitable by the technician. In some embodiments, the difference in time between when the technician has actually seen the task (e.g., by opening an email or other notification including the task) and when the technician accepts may be determined, in addition to or rather than the amount of time between assignment and acceptance.

If the technician does not accept the task, the task data may be categorized and/or updated with user input data at step 416. For example, if the technician determines that the task is not particularly profitable, the technician may hesitate to accept the task and may deliberate for a longer period of time. This may indicate that a particular task is priced improperly or priced properly depending on the circumstances. In either outcome, the difference in time may flag a particular task assignment for review (e.g., by a user) to better understand why the task was not immediately accepted by the technician.

As mentioned herein, one or more of historical task data and the task data may be subjected to pre-processing steps (e.g., mandatory and/or preferred transformations) to process the data prior to feeding the data to a machine learning model. An exemplary embodiment of a process 500 for pre-filtering the task data and/or the historical task data is shown in FIG. 5.

At step 502, the device 205 of FIG. 2 may receive the task data. At least a portion of the task data, e.g. a portion indicative of a scope of work for one or more tasks, may be input by a task generator 120 in a natural language format.

At step 504, each of the words in the scope of work may be converted to lower case text, all punctuation and stop words may be removed, and numbers in textual form may be converted to digital form. Because the individual tasks and the corpus of data used for the machine learning algorithms discussed herein are input by the task generator(s), the text may include capitalization. Converting the input text to lowercase may help preprocess the data with later natural language processing steps (e.g., parsing). Similarly, some or all of the punctuation and stop words (e.g., “and,” “but,” etc.) may be removed in order to make processing of the data easier. Some textual indications may be used, however, to generate more accurate evaluations (e.g., “symbol for “inches” or other indicators of units of measurement, etc.) Stop words may be removed from one or all portions of one or more of the generated tasks. Stop word removal may be based on the part of speech of the particular word(s) to be removed and/or the word(s) that the particular word(s) to be removed modify in the natural language text. In some embodiments, the stop word(s) may be removed based on whether the word is a part of a phrase or not. Additionally, because numbers can be important to the generation of an evaluation, the number values, which may be input by a task generator as a digital value, are converted to a text form (e.g., “1” becomes “one”).

At step 506, the text may be subjected to a word stemming. Word stemming may reduce the words in the text, which may be in different forms, to a core root or stem. The stemming process may be rule based, and the word(s) may be run through a series of conditionals that may determine how to stem the word. Example stemming algorithms may include a Porter stemmer, a snowball stemmer, and a Lancaster stemmer.

At step 508, the data may be subjected to a lemmatization process which may change any or all of the text in the task data to its dictionary or canonical form. For natural language (e.g., grammatical) reasons, the task data (e.g., work orders) may use different forms of a word (e.g., “organize,” “organizes,” and “organizing.”) Additionally, there are families of derivationally related words with similar meanings, (e.g., “democracy,” “democratic,” and “democratization.” For various reasons, it may be to reduce inflectional forms and sometimes derivationally related forms of a word to their common base form.

At step 510, the task data may be subjected to a key word selection or extraction. Key word selection may extract the most relevant words and expressions from a text. The key word selection may select single words (key words) or groups of two or more words that create a phrase (key phrases). In some embodiments, the key words extraction may include a key word assignment tool or algorithm. The key word selection tool may include a named entity recognition tool. Key word selection tools may include, but are not limited to, word frequency, word collocations and co-occurrences, TF-IDF (short for term frequency—inverse document frequency), and RAKE (Rapid Automatic Keyword Extraction). The key word selection may use one or more of a linguistic approach, a graph-based approach, a machine learning approach, or a hybrid approach. For example, in some embodiments, key words may be identified by using a machine learning model to learn associations between historical evaluations and historical natural language task date, e.g., in order to identify words in natural language data likely to have an effect on evaluations. In some embodiments, the performance of the key word selection may be evaluated using metrics such as accuracy, precision, recall, and F1 score, or recall-oriented understudy for gisting evaluation (“ROUGE”).

After the task data is received and subjected to one or more of the processes described in steps 504 through 510, the processed task data may be fed to one or more natural language processing engines at step 512 to generate features from the processed natural language. In some embodiments, such features may be a vector format or other format acceptable as input to the machine learning algorithms 215.

In general, any process or operation discussed in this disclosure that is understood to be computer-implementable, such as the processes illustrated in FIGS. 3, 4, and 5, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

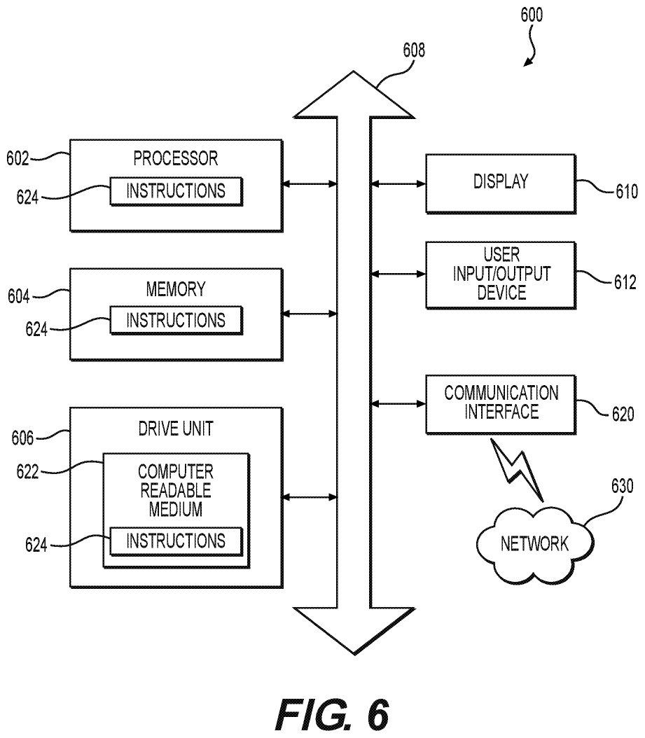

FIG. 6 is a simplified functional block diagram of a computer 600 that may be configured as a device for executing the methods of FIGS. 3, 4, and 5, according to exemplary embodiments of the present disclosure. For example, the computer 600 may be configured as the evaluation and assignment generation system 145 and/or another system according to exemplary embodiments of this disclosure. In various embodiments, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications (e.g., via the network 630). The computer 600 may also have a memory 604 (such as RAM) storing instructions 624 for executing techniques presented herein, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for using natural language data to analyze tasks via machine learning, comprising:
obtaining task data indicative of at least one task, and including natural language data associated with the at least one task;
converting the task data into task feature data; and
generating an evaluation of the at least one task by using a trained machine-learning model on the task feature data;
wherein the trained machine-learning model has been trained based on historical task feature data and historical evaluations associated with the historical task feature data to learn associations between the historical task feature data and the historical evaluations, so that the trained machine-learning model is configured to use the learned associations to generate the evaluation based on the task feature data.

2. The computer-implemented method of claim 1, wherein converting the task data into task feature data includes performing natural language processing on the natural language data.

3. The computer-implemented method of claim 2, wherein converting the task data into task feature data further includes, prior to performing the natural language processing, applying a predetermined filter to the natural language data.

4. The computer-implemented method of claim 3, wherein the predetermined filter has been determined by using learned associations between the historical evaluations and historical natural language data in historical task data associated with the historical evaluations, the learned associations indicative of words in the historical natural language data that are correlated to the historical evaluations.

5. The computer-implemented method of claim 1, wherein:
the task data further includes urgency data associated with the at least one task, and is indicative of an urgency of the at least one task; and
the historical task feature data is based on historical task data that includes historical urgency data, such that the learned associations of the trained machine-learning model are configured to account for the urgency data in the task data.

6. The computer-implemented method of claim 1, wherein:
the task data further includes task generator identity data associated with the at least one task, and is indicative of an identity of a task generator of the at least one task; and
the historical task feature data is based on historical task data that includes historical task generator identity data, such that the learned associations of the trained machine-learning model are configured to account for the task generator identity data in the task data.

7. The computer-implemented method of claim 1, wherein:
the task data further includes location data associated with the at least one task, and is indicative of a location of the at least one task; and
the historical task feature data is based on historical task data that includes historical location data, such that the learned associations of the trained machine-learning model are configured to account for the location data in the task data.

8. The computer-implemented method of claim 1, wherein:
the task data further includes service type data associated with the at least one task, and is indicative of a type of service provided in the at least one task; and
the historical task feature data is based on historical task data that includes historical service type data, such that the learned associations of the trained machine-learning model are configured to account for the service type data in the task data.

9. The computer-implemented method of claim 1, further comprising:
obtaining historical technician data indicative of at least one technician; and
generating an assignment of the at least one task based on the historical technician data.

10. The computer-implemented method of claim 1, further comprising:
generating a confidence interval of the evaluation of the at least one task, the confidence interval being a quantification of a certainty of the evaluation of the at least one task with reference to the historical evaluations associated with the historical task feature data, and wherein
the at least one task is automatically assigned to a technician based on the confidence interval.

11. A system for using natural language data to analyze tasks via machine learning, comprising:
a display;
a memory storing instructions and a trained machine learning model, wherein:
(i) the trained machine-learning model has been trained based on historical task feature data and historical evaluations associated with the historical task feature data to learn associations between the historical task feature data and the historical evaluations, and
(ii) the training has resulted in the trained machine learning model being configured to use the learned associations to generate an evaluation based on task feature data; and
a processor operatively connected to the display and the memory, and configured to execute the instructions to perform operations including:
obtaining task data indicative of at least one task, and including natural language data associated with the at least one task;
converting the task data into the task feature data; and
generating the evaluation of the at least one task by using the trained machine-learning model on the task feature data.

12. The system of claim 11, wherein converting the task data into task feature data includes performing natural language processing on the natural language data.

13. The system of claim 12, wherein converting the task data into task feature data further includes, prior to performing the natural language processing, applying a predetermined filter to the natural language data.

14. The system of claim 13, wherein the predetermined filter has been determined by using learned associations between the historical evaluations and historical natural language data in historical task data associated with the historical evaluations, the learned associations indicative of words in the historical natural language data that are correlated to the historical evaluations.

15. The system of claim 11, wherein:
the task data further includes urgency data associated with the at least one task, and is indicative of an urgency of the at least one task; and
the historical task feature data is based on historical task data that includes historical urgency data, such that the learned associations of the trained machine-learning model are configured to account for the urgency data in the task data.

16. The system of claim 11, wherein:
the task data further includes task generator identity data associated with the at least one task, and is indicative of an identity of a task generator of the at least one task; and
the historical task feature data is based on historical task data that includes historical task generator identity data, such that the learned associations of the trained machine-learning model are configured to account for the task generator identity data in the task data.

17. The system of claim 11, wherein:
the task data further includes location data associated with the at least one task, and is indicative of a location of the at least one task; and
the historical task feature data is based on historical task data that includes historical location data, such that the learned associations of the trained machine-learning model are configured to account for the location data in the task data.

18. A computer-implemented method for using natural language data to analyze tasks via machine learning, comprising:
obtaining task data indicative of at least one task, and including natural language data associated with the at least one task;
converting the task data into task feature data; and
generating an evaluation of the at least one task by using a trained machine-learning model on the task feature data;
wherein the trained machine-learning model has been trained based on historical task feature data and historical evaluations associated with the historical task feature data to learn associations between the historical task feature data and the historical evaluations, so that the trained machine-learning model is configured to use the learned associations to generate the evaluation based on the task feature data, and
automatically assigning the at least one task to a technician based on the evaluation of the at least one task.

19. The method of claim 18, wherein the task data includes user input data.

20. The method of claim 18, wherein automatically assigning the at least one task is based on a confidence interval of the evaluation of the at least one task, the confidence interval being a quantification of a certainty of the evaluation of the at least one task in light of the historical evaluations associated with the historical task feature data.
